(19) United States
(12) Patent Application Publication
(10) Pub. No.: US 2021/0331328 A1
(43) Pub. Date: Oct. 28, 2021

(54) ARTIFICIAL INTELLIGENCE ROBOT AND METHOD OF CONTROLLING THE SAME

(71) Applicant: LG ELECTRONICS INC., Seoul (KR)

(72) Inventor: Namgeon KIM, Seoul (KR)

(21) Appl. No.: 16/490,447

(22) PCT Filed: Jun. 17, 2019
(86) PCT No.: PCT/KR2019/007258

§ 371 Date: Aug. 30, 2019

(51) Int. Cl. B25J 13/00; B25J 11/00; B25J 9/00; G10L 17/24; G06F 21/32; G06Q 20/32; G06Q 20/40; G06K 9/00

(52) U.S. Cl. CPC B25J 13/003; B25J 11/0005; B25J 9/0003; G06K 9/00335; G06F 21/32; G06Q 20/3226; G06Q 20/40145; G10L 17/24

(57) ABSTRACT

The present disclosure provides an artificial-intelligence robot including a body having an internal accommodation space formed therein, a support part disposed below the body to support the body, a display configured to display an image, a head disposed on the body and having a front surface on which the display is disposed, a voice input unit including a plurality of microphones (MICs) receiving a voice signal, and a control unit configured to, upon receiving a payment command from a user, make a request for speech of a security code, receive speech data on the security code from the user, and perform user authentication by comparing the speech data with the security code and comparing the speech data with a stored voice of the user. Thus, it is possible to provide an artificial-intelligence robot that is more convenient to use by performing security authentication through a voice input.

### TECHNICAL FIELD

The present invention relates to an artificial-intelligence robot and a method of controlling a smart home system including the same. More particularly, the present invention relates to an artificial-intelligence home robot capable of providing a payment service and performing security authentication based on a voice input by a user when performing payment, and a method of controlling the same.

### BACKGROUND ART

Existing home appliances, such as washing machines, air conditioners, and cleaners, which are used at home or in the office, may individually perform their own functions and operations.

For example, a refrigerator stores food, a washing machine washes laundry, an air conditioner controls indoor temperature, and a cooking device cooks food.

Nowadays, with the development of various communication technologies, various home appliances are connected to each other via network connections through wired/wireless communication.

Because the home appliances are connected to each other over a network, data may be transmitted from one home appliance to another, or information on one home appliance may be checked through another home appliance.

Smart devices, such as a mobile terminal, may also be connected to the network, such that a user may check and control information on the home appliances using a smart device anytime and anywhere.

Such networking of home appliances may be called a smart home.

Regarding such smart home technology, a related art document (Korean Patent Application No. 10-2003-0093196) discloses a home network including a washing machine.

According to the related art, after a predetermined period of time upon completion of washing, the washing machine communicates with a user based on the presence of laundry and humidity, and performs a follow-up process in response to the result of the communication, thereby preventing damage to laundry left in the washing machine for an extended period of time.

That is, upon completion of washing, the washing machine in the home network transmits information regarding the left laundry and a query message asking whether to proceed with a follow-up process to a user's portable terminal, and upon receiving a response to the query message, performs a follow-up process in accordance with the response.

However, according to the conventional smart home technology described above, even when a user is at home, information on a specific home appliance is provided to the user or is controlled through a portable terminal. Therefore, there is an inconvenience in that the user needs to operate the portable terminal every time.

Meanwhile, robots have been developed for industrial uses, and have come to be used to manage some parts of factory automation. In recent years, robots have been applied to various fields, and, for example, medical robots, aerospace robots, home robots for use in ordinary homes, etc. have been developed.

Technologies for driving various home appliances using a home robot have been developed.

However, when it is desired to drive the home appliances or to perform shopping, it is difficult to perform user authentication for payment.

A home robot performs user authentication by identifying the user through voice recognition. However, in many cases, the user's voice is erroneously recognized. In addition, other types of biometrics, such as fingerprint or iris recognition, are still afflicted with problems related to personal information protection.

### RELATED ART DOCUMENT

[Patent Document]

Korean Patent Application No. 10-2003-0093196 (filed on Dec. 18, 2003)

### DISCLOSURE

### Technical Problem

It is an object of the present invention to provide a home robot that is more convenient to use by performing security authentication based on a voice input thereto, and a method of controlling the same.

It is another object of the present invention to provide a payment system using a home robot enabling accurate authentication merely by analyzing and verifying the voice of a user who utters a security code, which is generated in a random manner.

### Technical Solution

In accordance with one aspect of the present invention, there is provided a method of controlling a home robot, the method including receiving a payment command from a user, making a request for speech of a security code to the user, receiving speech data on the security code from the user within a predetermined time, and performing user authentication by analyzing the received speech data, comparing the analyzed speech data with the security code, and comparing the analyzed speech data with a stored voice of the user.

The method may further include, before the making a request for speech of the security code, generating the security code in a random manner, and providing the security code to the user.

The providing the security code may include providing the security code visually through a display of the home robot.

The performing user authentication may include performing voice recognition preprocessing with respect to the received speech data, analyzing an intention of the preprocessed speech data, and determining whether the analyzed speech data matches the security code.

The method may further include comparing the preprocessed speech data with stored user voice data to determine whether the preprocessed speech data matches the user voice data.

The providing the security code may include providing the security code to the user acoustically.

The making of a request for speech of the security code may further include making a request for a secret motion.

The secret motion and the security code may be preset.

The performing user authentication may include acquiring a secret motion provided by the user in the form of image data, acquiring a security code spoken by the user in the form of speech data, determining whether the secret motion matches a motion of the image data by performing motion recognition based on the image data, and determining whether the speech data matches the preset security code.

The method may further include determining whether the user authentication fails and is repeatedly performed a predetermined number of times, and, upon determining that the user authentication is repeatedly performed a predetermined number of times or more, terminating the operation for a payment request.

In accordance with another aspect of the present invention, there is provided a home robot including a body having an internal accommodation space formed therein, a support part disposed below the body to support the body, a display configured to display an image, a head disposed on the body and having a front surface on which the display is disposed, a voice input unit including a plurality of microphones (MICs) receiving a voice signal, and a control unit configured to, upon receiving a payment command from a user, make a request for speech of a security code, receive speech data on the security code from the user, and perform user authentication by comparing the speech data with the security code and comparing the speech data with a stored voice of the user.

Before making a request for speech of the security code, the control unit may generate the security code in a random manner, and may provide the security code to the user.

The control unit may provide the security code visually through the display.

The control unit may perform voice recognition preprocessing with respect to the received speech data, may analyze an intention of the preprocessed speech data, and may determine whether the analyzed speech data matches the security code.

The control unit may compare the preprocessed speech data with stored user voice data to determine whether the preprocessed speech data matches the user voice data.

The security code may be provided to the user acoustically.

The control unit may further make a request for a secret motion when making a request for speech of the security code.

The secret motion and the security code may be preset.

The control unit may acquire a secret motion provided by the user in the form of image data, may acquire a security code spoken by the user in the form of speech data, may determine whether the secret motion matches a motion of the image data by performing motion recognition based on the image data, and may determine whether the speech data matches the preset security code.

The control unit may determine whether the user authentication fails and is repeatedly performed a predetermined number of times, and, upon determining that the user authentication is repeatedly performed a predetermined number of times or more, may terminate the operation for a payment request.

### Advantageous Effects

According to at least one of the embodiments of the present invention, it is possible to provide a home robot that is more convenient to use by performing security authentication based on a voice input thereto.

In addition, it is possible to achieve accurate authentication merely by analyzing and verifying the voice of a user who utters a security code, which is generated in a random manner.

### DESCRIPTION OF DRAWINGS

FIG. 1 is a constitutional view of a smart home system including a home robot according to an embodiment of the present invention.

FIG. 2 is a front view illustrating the external appearance of the home robot according to the embodiment of the present invention.

FIG. 3 is a schematic block diagram of an example of the internal configuration of the home robot according to the embodiment of the present invention.

FIG. 4 is a flowchart illustrating a method of controlling the home robot according to an embodiment of the present invention.

FIGS. 5a and 5b are views illustrating the operation performed according to the control method shown in FIG. 4.

FIG. 6 is a flowchart illustrating a method of controlling the home robot according to another embodiment of the present invention.

FIG. 7 is a view illustrating the operation performed according to the control method shown in FIG. 6.

FIG. 8 is a flowchart illustrating a method of controlling the home robot according to still another embodiment of the present invention.

FIGS. 9a to 9c are views illustrating the operation performed according to the control method shown in FIG. 8.

### BEST MODE

Expressions referring to directions such as “front (F)/rear (R)/left (Le)/right (Ri)/upper (U)/lower (D)” mentioned below are defined based on the illustrations in the drawings, but this is merely given to describe the present invention for clear understanding thereof, and it goes without saying that the respective directions may be defined differently depending on where the reference is placed.

The use of terms in front of which adjectives such as “first” and “second” are used in the description of constituent elements mentioned below is intended only to avoid confusion of the constituent elements, and is unrelated to the order, importance, or relationship between the constituent elements. For example, an embodiment including only a second component but lacking a first component is also feasible.

The thickness or size of each constituent element shown in the drawings may be exaggerated, omitted or schematically drawn for the convenience and clarity of explanation. The size or area of each constituent element may not utterly reflect the actual size or area thereof.

Angles or directions used to describe the structure of the present invention are based on those shown in the drawings. Unless a reference point with respect to an angle or positional relationship in the structure of the present invention is clearly described in the specification, the related drawings may be referred to.

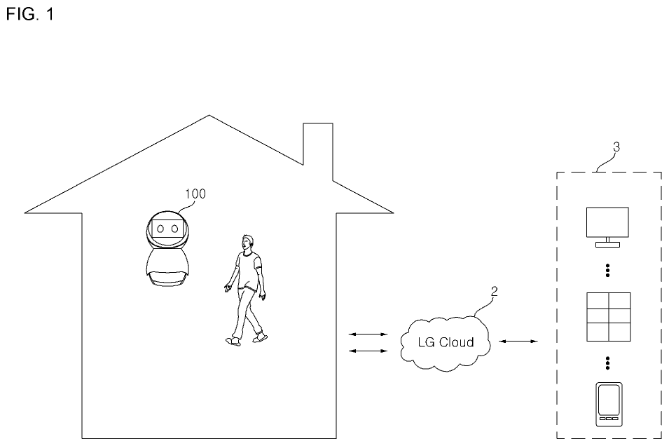

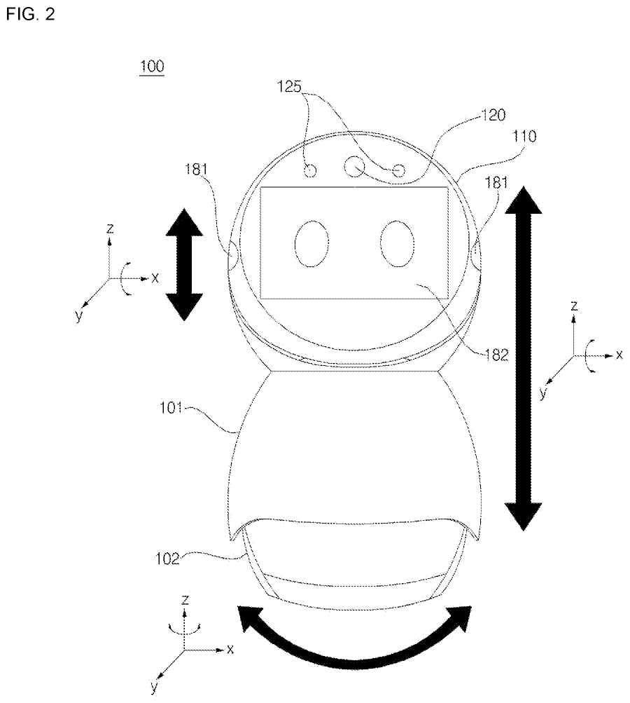

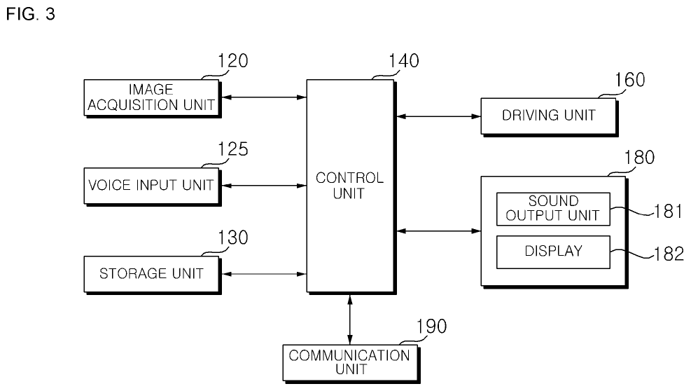

FIG. 1 is a constitutional view of an artificial-intelligence robot system according to an embodiment of the present invention, FIG. 2 is a view of a home robot 100 shown in FIG. 1, and FIG. 3 is a schematic block diagram of the internal configuration of the home robot according to the embodiment of the present invention.

Referring to FIGS. 1 to 3, the robot system according to the embodiment of the present invention may include at least one robot 100 for providing a service in a prescribed place such as a house. For example, the robot system may include a home robot 100, which interacts with a user at home and provides various forms of entertainment to the user. In addition, the home robot 100 may perform online shopping or online ordering and may provide a payment service in accordance with the user request.

Preferably, the robot system according to the embodiment of the present invention may include a plurality of artificial-intelligence robots 100 and a server 2 capable of managing and controlling the plurality of artificial-intelligence robots 100. The server 2 may monitor and control the status of the plurality of robots 1 from a remote place, and the robot system may provide a service more effectively using the plurality of robots 1.

The plurality of robots 100 and the server 2 may include a communication module (not shown), which supports one or more communication standards, so as to communicate with each other. In addition, the plurality of robots 100 and the server 2 may communicate with a PC, a mobile terminal, and another external server 2.

For example, the plurality of robots 100 and the server 2 may implement wireless communication using a wireless communication technology such as IEEE 802.11 WLAN, IEEE 802.15 WPAN, UWB, Wi-Fi, ZigBee, Z-wave, Bluetooth, or the like. The robots 100 may be configured differently depending on the type of communication of other devices, with which the robots 100 intend to communicate, or the server 2.

In particular, the plurality of robots 100 may communicate with another robot 100 and/or the server 2 in a wireless manner over a 5G network. When the robots 100 implement wireless communication over a 5G network, real-time response and real-time control are possible.

The user may confirm information on the robots 100 in the robot system through a user terminal 3 such as a PC or a mobile terminal.

The server 2 may be implemented as a cloud server 2, and the cloud server 2 may be interlocked with the robots 100 so as to monitor and control the robots 100 and remotely provide various solutions and contents.

The server 2 may store and manage information received from the robots 100 and other devices. The server 2 may be a server 2 that is provided by a manufacturer of the robots 100 or a company entrusted with the service by the manufacturer. The server 2 may be a control server 2 that manages and controls the robots 100.

The server 2 may control the robots 100 collectively and uniformly, or may control the robots 100 individually. Meanwhile, the server 2 may be implemented as multiple servers to which pieces of information and functions are dispersed, or may be implemented as a single integrated server.

The robots 100 and the server 2 may include a communication module (not shown), which supports one or more communication standards, for communication therebetween.

The robots 100 may transmit data related to space, objects, and usage to the server 2.

Here, the data related to space and objects may be data related to recognition of space and objects that is recognized by the robots 100, or may be image data on space and objects that is acquired by an image acquisition unit.

Depending on the embodiment, the robots 100 and the server 2 may include artificial neural networks (ANN) in the form of software or hardware that has learned to recognize at least one of a user, a voice, properties of space, or properties of an object such as an obstacle.

According to the embodiment of the present invention, the robots 100 and the server 2 may include a deep neural network (DNN), such as a convolutional neural network (CNN), a recurrent neural network (RNN), or a deep belief network (DBN), which has been trained through deep learning. For example, the control unit 140 of each robot 100 may be equipped with a deep neural network (DNN) structure such as a convolutional neural network (CNN).

The server 2 may train the deep neural network (DNN) based on data received from the robots 100 or data input by the user, and thereafter may transmit the updated data on the deep neural network (DNN) structure to the robots 1. Accordingly, the artificial-intelligence deep neural network (DNN) structure provided in the robots 100 may be updated.

Data related to usage may be data acquired in accordance with use of the robots 100. Data on use history or a sensing signal acquired through a sensor unit 110 may correspond to the data related to usage.

The trained deep neural network (DNN) structure may receive input data for recognition, may recognize properties of people, objects, and space included in the input data, and may output the result of recognition.

In addition, the trained deep neural network (DNN) structure may receive input data for recognition, may analyze and learn data related to usage of the robots 100, and may recognize a usage pattern and a usage environment.

Meanwhile, the data related to space, objects, and usage may be transmitted to the server 2 via a communication unit 190.

The server 2 may train the deep neural network (DNN) based on the received data, and thereafter may transmit the updated data on the deep neural network (DNN) structure to the artificial-intelligence robots 100 so that the robots update the deep neural network (DNN) structure.

Accordingly, the robots 100 may continually become smarter, and may provide a user experience (UX) that evolves as the robots 100 are used.

The robots 100 and the server 2 may also use external information. For example, the server 2 may comprehensively use external information acquired from other related service servers (not shown), and may provide an excellent user experience.

In addition, according to the present invention, the robots 100 may actively provide information first, or may output a voice that recommends a function or a service, thereby providing more diverse and proactive control functions to the user.

FIG. 2 is a front view showing the external appearance of a home robot 100 capable of providing a medication service to the user.

Referring to FIG. 2, the home robot 100 includes main bodies 101 and 102, which define the external appearance of the home robot and accommodate various components therein.

The main bodies 101 and 102 may include a body 111, which forms a space in which various components constituting the home robot 100 are accommodated, and a support part 112, which is disposed below the body 111 and supports the body 111.

The home robot 100 may include a head 110 disposed on the main bodies 101 and 102. A display 182 capable of displaying an image may be disposed on the front surface of the head 110.

In this specification, the forward direction may be a +y-axis direction, the upward-and-downward direction may be a z-axis direction, and the leftward-and-rightward direction may be an x-axis direction.

The head 110 may rotate within a predetermined angular range about the x-axis.

Thus, when viewed from the front, the head 110 may perform a nodding operation of moving in the upward-and-downward direction like a person who nods his/her head in the upward-and-downward direction. For example, the head 110 may perform an operation of returning to the original position after rotating within a predetermined range once or more like a person who nods his/her head in the upward-and-downward direction.

Meanwhile, depending on the embodiment, at least a portion of the front surface of the head 110, on which the display 182 corresponding to the face of a person is disposed, may be configured to nod.

As such, the embodiment is described with reference to a configuration in which the entire head 110 moves in the upward-and-downward direction. However, unless specifically stated, the nodding operation of the head 110 in the upward-and-downward direction may be substituted with an operation in which at least a portion of the front surface on which the display 182 is disposed nods in the upward-and-downward direction.

The body 111 may be configured to be rotatable in the leftward-and-rightward direction. That is, the body 111 may be configured so as to rotate 360 degrees about the z-axis.

Further, depending on the embodiment, the body 111 may also be configured to be rotatable within a predetermined angular range about the x-axis, so that it may move in the upward-and-downward direction like nodding. In this case, when the body 111 rotates in the upward-and-downward direction, the head 110 may also rotate together about the axis about which the body 111 rotates.

The home robot 100 may include an image acquisition unit 120, which is capable of capturing an image of the surroundings of the bodies 101 and 102 or at least a region within a predetermined range with respect to the front surfaces of the bodies 101 and 102.

The image acquisition unit 120 may capture an image of the surroundings or the external environment of the bodies 101 and 102, and may include a camera module. A plurality of cameras may be installed at various parts in order to improve image-capturing efficiency. Preferably, the image acquisition unit 120 may include a front camera, which is provided on the front surface of the head 110 in order to capture a forward image of the bodies 101 and 102.

In addition, the home robot 100 may include a voice input unit 125 for receiving a voice input by the user.

The voice input unit 125 may include a processing unit for converting analog sound into digital data, or may be connected to the processing unit in order to convert a voice signal input by the user into data so that the server 2 or the control unit 140 may recognize the voice signal.

The voice input unit 125 may include a plurality of microphones in order to increase the accuracy of reception of the voice input by the user and to determine the location of the user.

For example, the voice input unit 125 may include at least two microphones.

A plurality of microphones (MICs) may be disposed at different positions so as to be spaced apart from each other, and may acquire an external audio signal including a voice signal and convert the same into an electrical signal.

In order to estimate the direction of a sound source generating sound or the direction of the user, at least two microphones, which are input devices, are required. As the distance between the microphones is longer, the resolution (angle) of direction detection becomes higher. Depending on the embodiment, two microphones may be disposed on the head 110. Further, two additional microphones may be provided on the rear surface of the head 110, thereby enabling determination of the location of the user in three-dimensional space.

Further, sound output units 181 may be disposed on the left and right sides of the head 110 so as to output predetermined information in the form of sound.

The external appearance and structure of the robot 100 shown in FIG. 2 are merely illustrative, and the present invention is not limited thereto. For example, unlike the rotation direction of the robot 100 illustrated in FIG. 2, the entire robot 100 may be inclined in a specific direction, or may be shaken.

The home robot 100 may include a power supply unit (not shown), which is connected to a household socket and supplies power to the home robot 100.

Alternatively, the home robot 100 may include a power supply unit (not shown), which is provided with a rechargeable battery (not shown) to supply power to the home robot 100. Depending on the embodiment, the power supply unit (not shown) may include a wireless power-receiving unit for wirelessly charging the battery.

The home robot 100 may include an image acquisition unit 120, which is capable of capturing an image of the surroundings of the bodies 101 and 102 or at least a region within a predetermined range with respect to the front surfaces of the bodies 101 and 102.

The image acquisition unit 120 may capture an image of the surroundings or the external environment of the bodies 101 and 102, and may include a camera module. The camera module may include a digital camera. The digital camera may include at least one optical lens, an image sensor (e.g. a CMOS image sensor) including a plurality of photodiodes (e.g. pixels) on which an image is formed by light transmitted through the optical lens, and a digital signal processor (DSP), which constructs an image based on signals output from the photodiodes. The digital signal processor may generate not only a still image but also a video consisting of frames constituted by still images.

A plurality of cameras may be installed at various parts in order to improve image-capturing efficiency. Preferably, the image acquisition unit 120 may include a front camera, which is provided on the front surface of the head 110 in order to capture a forward image of the bodies 101 and 102. However, the number, arrangement, type, and photographing range of the cameras included in the image acquisition unit 120 are not necessarily limited to the above description.

The image acquisition unit 120 may capture a forward image of the home robot 100, and may capture an image for user recognition.

In addition, the image captured and acquired by the image acquisition unit 120 may be stored in a storage unit 130.

In addition, the home robot 100 may include a voice input unit 125 for receiving a voice input by the user.

The voice input unit 125 may include a processing unit for converting analog sound into digital data, or may be connected to the processing unit in order to convert a voice signal input by the user into data so that the server 70 or the control unit 140 may recognize the voice signal.

The voice input unit 125 may include a plurality of microphones in order to increase the accuracy of reception of the voice input by the user and to determine the location of the user.

For example, the voice input unit 125 may include at least two microphones.

A plurality of microphones (MICs) may be disposed at different positions so as to be spaced apart from each other, and may acquire an external audio signal including a voice signal and convert the same into an electrical signal.

In order to estimate the direction of a sound source generating sound or the direction of the user, at least two microphones, which are input devices, are required. As the distance between the microphones is longer, the resolution (angle) of direction detection becomes higher.

Depending on the embodiment, two microphones may be disposed on the head 110.

Further, two additional microphones may be provided on the rear surface of the head 110, thereby enabling determination of the location of the user in three-dimensional space.

Referring to FIG. 3, the home robot 100 may include a control unit 140 for controlling the overall operation of the home robot, a storage unit 130 for storing various data, and a communication unit 190 for transmitting and receiving data to and from other devices such as the server 2.

In addition, the home robot 100 may further include a driving unit 160 for rotating the head 110 and the body 101. The driving unit 160 may include a plurality of driving motors (not shown) for rotating and/or moving the body 101 and the head 110.

The control unit 140 controls the overall operation of the home robot 100 by controlling the image acquisition unit 120, the driving unit 160, and the display 182, which constitute the home robot 100.

The storage unit 130 may record various pieces of information required to control the home robot 100, and may include a volatile or nonvolatile recording medium. The recording medium may store data readable by a microprocessor, and may include a hard disk drive (HDD), a solid-state disk (SSD), a silicon disk drive (SDD), ROM, RAM, a CD-ROM, magnetic tape, a floppy disk, an optical data storage device, and the like.

The control unit 140 may transmit the operation state of the home robot 100 or the user input to the server 2 via the communication unit 190.

The communication unit 190 may include at least one communication module to allow the home robot 100 to be connected to the internet or a predetermined network therethrough.

In addition, the communication unit 190 is connected to a communication module provided in a home appliance (not shown) to process data transmission/reception between the home robot 100 and the home appliance (not shown).

Meanwhile, the storage unit 130 may store data for voice recognition, and the control unit 140 may process the voice signal input by the user, which is received through the voice input unit 125, and may perform a voice recognition process.

In the voice recognition process, various known voice recognition algorithms may be used. In particular, preprocessing, such as tokenization, POS tagging, and stopword processing, may be performed on the received voice by implementing a natural language processing (NLP) algorithm, and the meaning of the voice data may be accurately analyzed through feature extraction, modeling, and inference based on the preprocessed data.

At this time, the control unit 140 may implement a deep learning algorithm such as RNN or CNN, or may employ various types of machine learning modeling.

The control unit 140 may control the home robot 100 to perform a predetermined operation based on the voice recognition result.

For example, when the command included in the voice signal is a command for controlling the operation of a predetermined home appliance, the control unit 140 may perform control so as to transmit a control signal based on the command included in the voice signal to the target home appliance to be controlled.

In addition, when the command included in the voice signal of the user is a command for performing user authentication for payment, the control unit 140 may activate a security system to execute the user authentication, and may transmit the payment information to the seller.

Depending on the embodiment, the control unit 140 may compare the image of the user acquired through the image acquisition unit 120 with information stored in the storage unit 130, and may determine whether the user is a registered user.

The voice recognition process may not be performed by the home robot 100, but may be performed by the server 2.

In this case, the control unit 140 may control the communication unit 190 so that the voice signal input by the user is transmitted to the server 2. Alternatively, a simple voice recognition operation may be performed by the home robot 100, and a high-level voice recognition operation such as natural language processing may be performed by the server 2.

Further, the control unit 140 may perform control such that a specific operation is performed only in response to the input of the voice of the registered user.

Furthermore, the control unit 140 may identify a user having control authority over the home robot 100. Upon identifying the user having control authority, the control unit 140 may control the head 110 to nod. Accordingly, the user may intuitively perceive that the home robot 100 has identified the user.

The control unit 140 may control the rotation of the body 101 and/or the head 111 based on the user image information acquired by the image acquisition unit 120.

The control unit 140 may rotate the body 101 in the leftward-and-rightward direction based on the user image information. For example, when the number of faces included in the user image information is one, the body 101 may be rotated in the leftward-and-rightward direction such that the face included in the user image information is located at the center of the camera of the image acquisition unit 120.

Further, the control unit 140 may control the rotation of the head 111 in the upward-and-downward direction such that the display 182 is oriented toward the face included in the user image information, thus enabling the user to more easily confirm the information displayed on the display 182.

Furthermore, this may enable the home robot 100 to more effectively identify the user and perform a specific subsequent operation such as photographing.

Accordingly, interaction and communication between the user and the home robot 100 may be facilitated.

When the number of faces included in the user image information is plural, the control unit 140 may control the rotation of the body 101 of the home robot 100 such that the average value of the positions of the plurality of faces included in the user image information is located at the center of the camera of the image acquisition unit 120.

Since the home robot 100 is used at home, a plurality of family members may use the home robot 100 together. In this case, when other family members are present near the user who is speaking, it may be more natural for the home robot 100 to be oriented toward the average value of the positions of the plurality of users, rather than being oriented toward a specific family member.

Furthermore, this may enable the home robot to more effectively identify a plurality of users and perform a specific operation such as group photographing of a plurality of users, e.g. family members.

Depending on the embodiment, even when a plurality of users is recognized, the home robot may be set to be oriented toward a user who speaks.

The control unit 140 may control the rotation of the body 101 based on at least one of the number of faces, face location information, or face area information included in the acquired user image information.

The size of the face in the image acquired by the image acquisition unit 120 varies depending on the distance between the user and the home robot 100. Accordingly, the home robot 100 may be controlled so as to be oriented toward an optimum location by taking into account the number of users, the locations of the users, and face area information included in the image acquired by the image acquisition unit 120.

The home robot 100 may include an output unit 180 for displaying predetermined information in the form of an image or outputting the same in the form of a sound.

The output unit 180 may include a display 182 for displaying information corresponding to a command input by the user, a processing result corresponding to a command input by the user, an operation mode, an operation state, an error state, and the like in the form of an image.

The display 182 may be disposed on the front surface of the head 110, as described above.

Depending on the embodiment, the display 182 may be implemented as a touch screen that forms a mutual layer structure with a touch pad. In this case, the display 182 may be used not only as an output device but also as an input device that receives information input by user touch.

In addition, the output unit 180 may further include a sound output unit 181 for outputting an audio signal. The sound output unit 181 may output a notification message, such as a warning sound, an operation mode, an operation state, and an error state, information corresponding to a command input by the user, a processing result corresponding to a command input by the user, and the like in the form of a sound. The sound output unit 181 may convert an electrical signal from the control unit 140 into an audio signal, and may output the audio signal. To this end, the sound output unit may include a speaker.

Referring to FIG. 2, the sound output unit 181 may be disposed on each of the left and right sides of the head 110, and may output predetermined information in the form of a sound.

The external appearance and structure of the home robot shown in FIG. 2 are merely illustrative, and the present invention is not limited thereto. For example, the locations of the voice input unit 125, the image acquisition unit 120 and the sound output unit 181 and the numbers thereof may vary depending on the design specifications, and the rotation direction and angle of each component may also vary.

The home robot 100 may provide not only various entertainment functions but also a service that allows a user to perform various types of shopping or ordering at home.

At this time, the home robot 100 may perform user authentication. When the user asks the home robot to provide a service such as shopping or ordering, the home robot 100 may activate a predetermined security system to perform user authentication.

Specifically, the user may instruct the home robot 100 to connect to a specific shopping mall, to choose a specific item, and to pay for the same. At this time, the home robot 100 may activate the security system to perform user authentication in response to the payment command of the user.

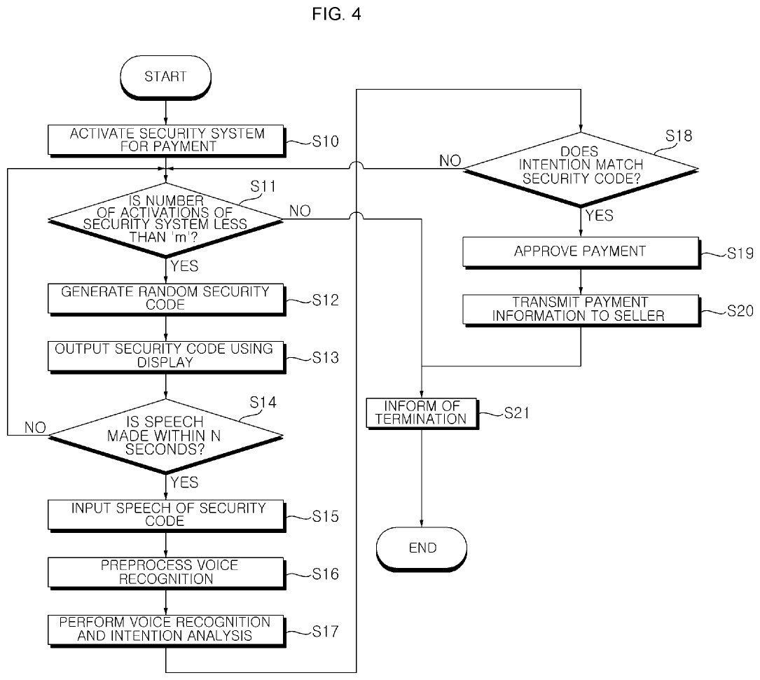

Hereinafter, the operation of the security system of the artificial-intelligence home robot according to various embodiments of the present invention will be described with reference to FIGS. 4 to 9.

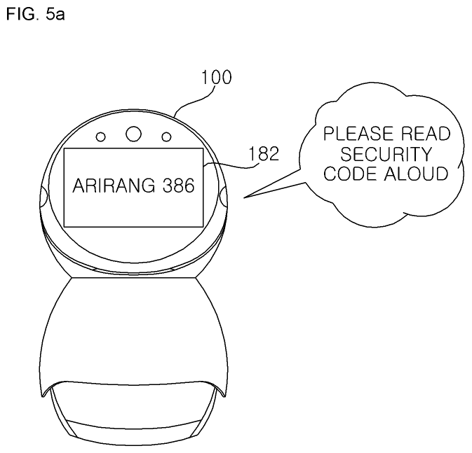

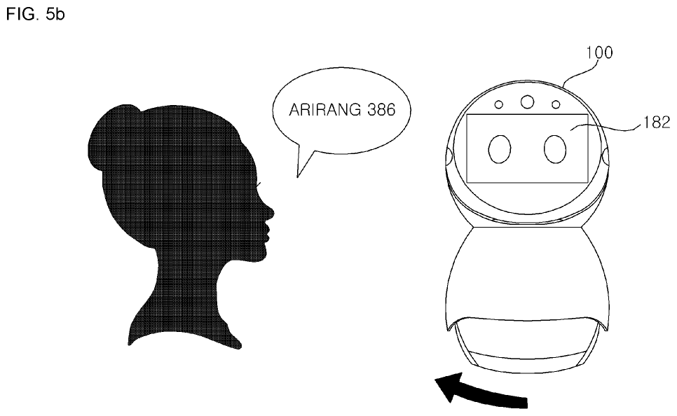

FIG. 4 is a flowchart illustrating a method of controlling the home robot according to an embodiment of the present invention, and FIGS. 5a and 5b are views illustrating the operation performed according to the control method shown in FIG. 4.

Referring to FIG. 4, the home robot 100 according to the embodiment of the present invention activates the security system upon receiving a payment command from a user through a plurality of microphones (MICs) included in the voice input unit 125 (S10).

When the security system is activated, the control unit 140 determines whether the number of iterations of activation of the security system is less than ‘m’ (S11).

That is, when the security system is successively activated more than a predetermined number of times and payment is not made several times, the security system is terminated, and the user is informed of the refusal by the security system through the display 182 or the sound output unit 181.

When the security system is successively activated less than the number of times ‘m’, the control unit 140 generates a random security code (S12).

The security code may be a combination of random numbers, e.g. a combination of Korean letters, alphabets, and digits, the total number of which is equal to or less than a predetermined number, and may exclude symbols that may be read in multiple ways.

At this time, the number of letters in the security code may be arbitrarily determined, and the combination of random numbers is performed according to the determined number of letters.

The control unit 140 outputs the security code generated in this manner through the display 182 in order to provide the same to the user (S13).

At this time, as shown in FIG. 5a, the home robot 100 may also provide the user with a speech request such as “Please read the security code aloud” through the sound output unit 125.

In this manner, the home robot may provide the security code to the user visually and acoustically, and may request feedback on the same.

After outputting a speech request to the user through the sound output unit 181, the control unit 140 determines whether a user's speech is received within n seconds (S14).

At this time, only the user's speech made within n seconds, preferably 5 seconds, more preferably 3 seconds, may be accepted. When the user's speech is made after n seconds, it is determined that the user fails to acquire the security code, and the security system is activated again.

As shown in FIG. 5b, when the user's speech is input, i.e. when the user reads the corresponding security code aloud within n seconds (S15), the control unit 140 performs preprocessing for voice recognition (S16).

In the preprocessing, tokenization, POS tagging, and stopword processing may be performed on the received speech of the security code by implementing a natural language processing (NLP) algorithm, thereby filtering the corresponding speech data.

Subsequently, the control unit 140 performs voice recognition and intention analysis, thereby accurately analyzing the intention of the speech data through feature extraction, modeling, and inference based on the preprocessed speech data (S17).

In addition, the control unit 140 may recognize the speaker by performing frequency matching in order to determine whether the preprocessed speech data matches the stored user's voice. Upon determining that the preprocessed speech data matches the stored user's voice, the control unit 140 may accurately analyze the intention of the speech data by performing a deep learning algorithm such as RNN or CNN or applying various types of machine learning modeling.

Subsequently, the result of analyzing the intention of the speech data is compared with the current security code generated in the security system (S18).

At this time, it may be determined that the above two values are the same as each other not only when the matching rate therebetween is 100% but also when the matching rate therebetween reaches 80% or more, preferably 90% or more.

Subsequently, when it is determined that the security code and the result of analyzing the intention of the speech data are the same as each other, the user is informed that payment is approved and that user authentication is successful (S19).

Subsequently, the home robot 100 transmits the intention to purchase the item selected by the user and data on payment to the server. The intention to purchase the item and the data on payment are transmitted to the server of the seller and the server of the financial company, and payment is made through the stored card information or account information (S20).

As described above, while the user authentication is physically performed by comparing the user voice data with the stored voice, the random security code, which is a random number code, is generated and is provided to the user, and the user speech data, generated by reading the security code aloud, is compared with the security code, thereby enabling enhanced user authentication.

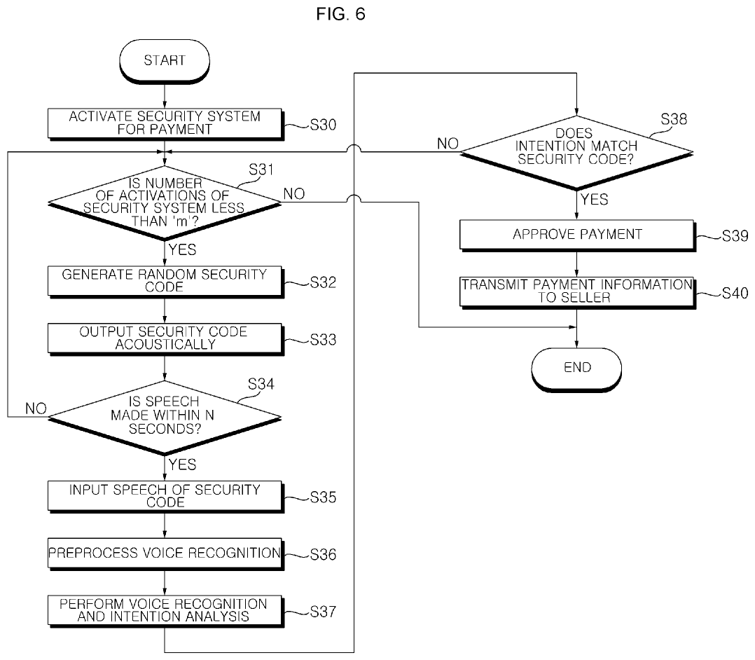

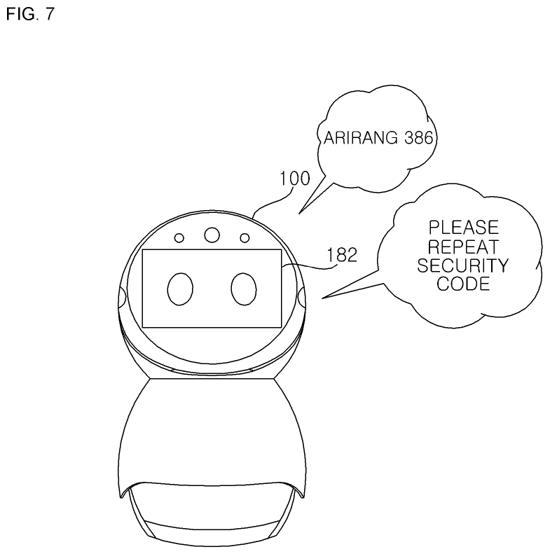

FIG. 6 is a flowchart illustrating a method of controlling the home robot 100 according to another embodiment of the present invention, and FIG. 7 is a view illustrating the operation performed according to the control method shown in FIG. 6.

Referring to FIG. 6, the home robot 100 according to another embodiment of the present invention activates the security system upon receiving a payment command from a user through a plurality of microphones (MICs) included in the voice input unit 125 (S30).

When the security system is activated, the control unit 140 determines whether the number of iterations of activation of the security system is less than ‘m’ (S31).

That is, when the security system is successively activated more than a predetermined number of times and payment is not made several times, the security system is terminated, and the user is informed of the refusal by the security system through the display 182 or the sound output unit 181.

When the security system is successively activated less than the number of times ‘m’, the control unit 140 generates a random security code (S32).

The security code may be a combination of random numbers, e.g. a combination of Korean letters, alphabets, and digits, the total number of which is equal to or less than a predetermined number, and may exclude symbols that may be read in multiple ways.

At this time, the number of letters in the security code may be arbitrarily determined, and the combination of random numbers is performed according to the determined number of letters.

The control unit 140 outputs the security code generated in this manner in the form of a sound through the sound output unit 181 in order to provide the same to the user (S33).

In one example, when the security code is “arirang 386”, as shown in FIG. 7, the security code is provided to the user through the sound output unit 181 in the form of a sound.

Subsequently, as shown in FIG. 7, the home robot 100 may also provide the user with a speech request such as “Please repeat the security code” through the sound output unit 181.

In this manner, the home robot may provide the security code to the user acoustically, and may request feedback on the same.

After outputting a speech request to the user through the sound output unit 181, the control unit 140 determines whether a user's speech is received within n seconds (S34).

At this time, only the user's speech made within n seconds, preferably 5 seconds, more preferably 3 seconds, may be accepted. When the user's speech is made after n seconds, it is determined that the user fails to acquire the security code, and the security system is activated again.

When the user's speech is input, i.e. when the user repeats the corresponding security code within n seconds (S35), the control unit 140 performs preprocessing for voice recognition (S36).

In the preprocessing, tokenization, POS tagging, and stopword processing may be performed on the received speech of the security code by implementing a natural language processing (NLP) algorithm, thereby filtering the corresponding speech data.

Subsequently, the control unit 140 performs voice recognition and intention analysis, thereby accurately analyzing the intention of the speech data through feature extraction, modeling, and inference based on the preprocessed speech data (S37).

In addition, the control unit 140 may recognize the speaker by performing frequency matching in order to determine whether the preprocessed speech data matches the stored user's voice. Upon determining that the preprocessed speech data matches the stored user's voice, the control unit 140 may accurately analyze the intention of the speech data by performing a deep learning algorithm such as RNN or CNN or applying various types of machine learning modeling.

Subsequently, the result of analyzing the intention of the speech data is compared with the current security code generated in the security system (S38).

At this time, it may be determined that the above two values are the same as each other not only when the matching rate therebetween is 100% but also when the matching rate therebetween reaches 80% or more, preferably 90% or more.

Subsequently, when it is determined that the security code and the result of analyzing the intention of the speech data are the same as each other, the user is informed that payment is approved and that user authentication is successful (S39).

Subsequently, the home robot 100 transmits the intention to purchase the item selected by the user and data on payment to the server. The intention to purchase the item and the data on payment are transmitted to the server of the seller and the server of the financial company, and payment is made through the stored card information or account information (S40).

As described above, while the user authentication is physically performed by comparing the user voice data with the stored voice, the random security code, which is a random number code, is generated and is provided to the user, and the user speech data, generated by reciting the security code, is compared with the security code, thereby enabling enhanced user authentication.

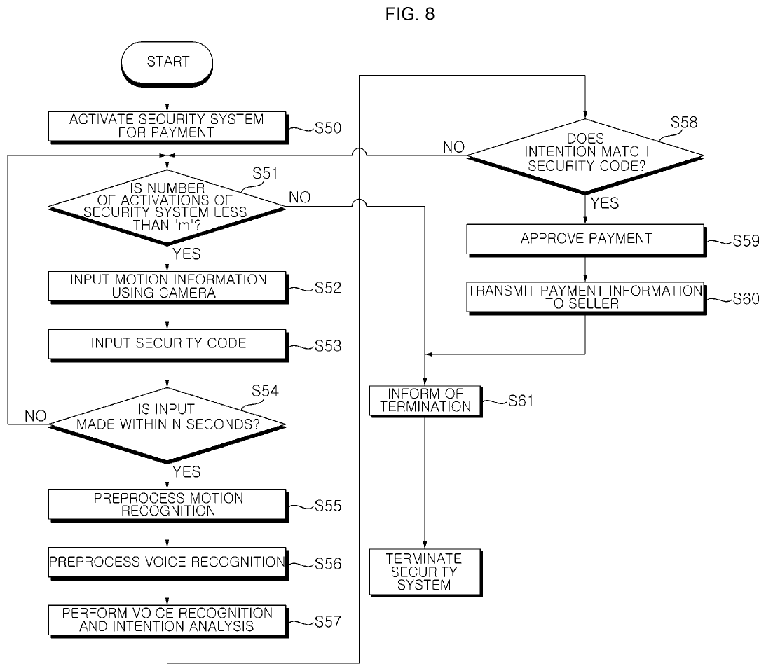

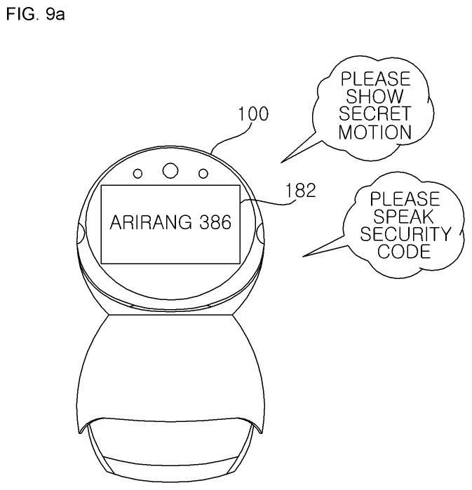

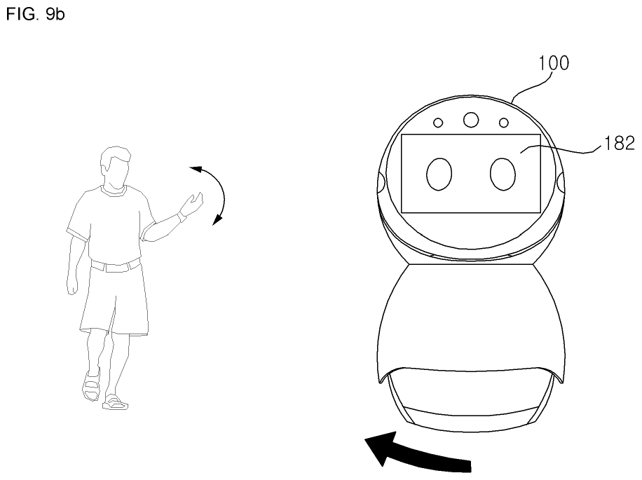

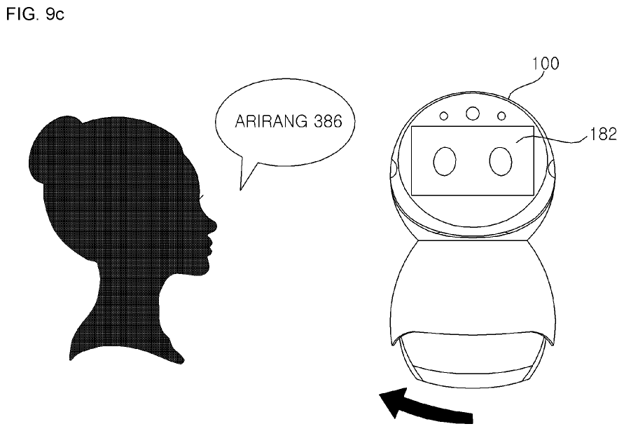

FIG. 8 is a flowchart illustrating a method of controlling the home robot 100 according to still another embodiment of the present invention, and FIGS. 9a to 9c are views illustrating the operation performed according to the control method shown in FIG. 8.

Referring to FIG. 8, the home robot 100 according to still another embodiment of the present invention activates the security system upon receiving a payment command from a user through a plurality of microphones (MICs) included in the voice input unit 125 (S50).

According to this embodiment, it is assumed that a preset security code and a preset secret motion are present between the user and the home robot 100. The security code and the secret motion may be set in the process of initially setting the home robot 100, and the setting may be easily performed in the setting menu of the home robot 100.

When the security system is activated, the control unit 140 determines whether the number of iterations of activation of the security system is less than ‘m’ (S51).

That is, when the security system is successively activated more than a predetermined number of times and payment is not made several times, the security system is terminated, and the user is informed of the refusal by the security system through the display 182 or the sound output unit.

When the security system is successively activated less than the number of times ‘m’, as shown in FIG. 9a, the control unit 140 may provide the user with a secret motion request such as “Please show the secret motion” in the form of a sound, and thereafter may provide the user with a speech request such as “Please speak the security code” in the form of a sound.

As shown in FIG. 9b, the control unit 140 acquires the secret motion of the user through the image acquisition unit 125 (S52).

The preset secret motion may be a motion that is simple and relatively easily distinguished, such as a motion of waving one hand, bowing the head, waving two hands, or raising the hand.

The control unit 140 may determine motion information included in the image acquired through the image acquisition unit 120 using facial recognition technology or motion recognition technology.

Various technologies for motion recognition are already known, and the present invention may use various well-known motion recognition algorithms. A method of detecting a geometrically characteristic element of the human body or a method of recognizing a face by detecting edge information and discriminating between the edge information and surrounding data may also be used.

For example, when fast recognition is required, facial recognition technology using geometric features of a face may be used. This technology is one among commonly used various facial recognition technologies. This technology recognizes an individual face or the shape thereof using geometric factors or elements such as the locations or sizes of feature points of the face such as the eyes, nose, and mouth, or the distances therebetween.

When the motion information is input, the control unit 140 may make a request for user speech and may acquire the security code from the user (S53).

That is, as shown in FIG. 9c, when the preset security code is “arirang 386”, the control unit acquires the user speech of the same through the voice input unit 125.

Subsequently, the control unit 140 determines whether the motion and the speech are received from the user within n seconds after outputting the requests to the user through the sound output unit 181 (S54).

At this time, only the motion and the speech input within n seconds, preferably 10 seconds, more preferably 5 seconds, may be accepted. When the motion and the speech are input after n seconds, it is determined that the acquisition of the security code has failed, and the security system is activated again.

When the motion is input within n seconds, the control unit 140 performs preprocessing for motion recognition (S55). That is, the control unit analyzes the corresponding motion by extracting the feature points of the respective frames, and determines whether the analyzed motion matches the preset secret motion.

Subsequently, the control unit 140 performs preprocessing for voice recognition with respect to the security code speech data (S56). In the preprocessing, tokenization, POS tagging, and stopword processing may be performed on the received speech of the security code by implementing a natural language processing (NLP) algorithm, thereby filtering the corresponding speech data.

Subsequently, the control unit 140 performs voice recognition and intention analysis, thereby accurately analyzing the intention of the speech data through feature extraction, modeling, and inference based on the preprocessed speech data (S57).

In addition, the control unit 140 may recognize the speaker by performing frequency matching in order to determine whether the preprocessed speech data matches the stored user's voice. Upon determining that the preprocessed speech data matches the stored user's voice, the control unit 140 may accurately analyze the intention of the speech data by performing a deep learning algorithm such as RNN or CNN or applying various types of machine learning modeling.

Subsequently, the result of analyzing the intention of the speech data is compared with the preset security code in the current security system (S58).

At this time, it may be determined that the above two values are the same as each other not only when the matching rate therebetween is 100% but also when the matching rate therebetween reaches 80% or more, preferably 90% or more.

Subsequently, when it is determined that the user's motion matches the preset secret motion and that the security code and the result of analyzing the intention of the speech data are the same as each other, the user is informed that payment is approved and that user authentication is successful (S59).

Subsequently, the home robot 100 transmits the intention to purchase the item selected by the user and data on payment to the server. The intention to purchase the item and the data on payment are transmitted to the server of the seller and the server of the financial company, and payment is made through the stored card information or account information (S60).

As described above, while the user authentication is physically performed by comparing the user voice data with the stored voice, the home robot requests the user to speak the security code in the form of a sound, and further requests the user to perform a secret motion, thereby enabling enhanced user authentication.

The home robot 100 according to the present invention is not limitedly applied to the constructions and methods of the embodiments as previously described; rather, all or some of the embodiments may be selectively combined to achieve various modifications.

Meanwhile, the home robot 100 and the method of operating the smart home system including the same according to the embodiment of the present invention may be implemented as code that can be written on a processor-readable recording medium and thus read by a processor. The processor-readable recording medium may be any type of recording device in which data is stored in a processor-readable manner. The processor-readable recording medium may include, for example, ROM, RAM, CD-ROM, magnetic tape, a floppy disk, and an optical data storage device, and may be implemented in the form of a carrier wave transmitted over the Internet. In addition, the processor-readable recording medium may be distributed over computer systems connected via a network such that processor-readable code is written thereto and executed therefrom in a decentralized manner.

While this invention has been particularly shown and described with reference to exemplary embodiments thereof, it will be understood by those skilled in the art that various changes in form and details may be made therein without departing from the spirit and scope of the invention as defined by the appended claims.

### DESCRIPTION OF REFERENCE NUMERALS

server: 2
home robot: 100
display: 182
sound output unit: 181
control unit: 140

1. A method of controlling a robot, the method comprising:
receiving a payment command from a user;
providing a request for speech of a security code to the user;
receiving speech data on the security code from the user within a predetermined time; and
performing user authentication by analyzing the received speech data, comparing the analyzed speech data with the security code, and comparing the analyzed speech data with a stored voice of the user.

2. The method of claim 1, further comprising, before the providing a request for speech of the security code:
generating the security code in a random manner; and
providing the security code to the user.

3. The method of claim 2, wherein the providing the security code comprises providing the security code visually through a display of the robot.

4. The method of claim 1, wherein the performing user authentication comprises:
performing voice recognition preprocessing with respect to the received speech data;
analyzing an intention of the preprocessed speech data; and
determining whether the analyzed speech data matches the security code.

5. The method of claim 4, further comprising:
comparing the preprocessed speech data with stored user voice data to determine whether the preprocessed speech data matches the user voice data.

6. The method of claim 2, wherein the providing the security code comprises providing the security code to the user acoustically.

7. The method of claim 1, wherein the providing a request for speech of the security code further comprises making a request for a secret motion.

8. The method of claim 7, wherein the secret motion and the security code are preset.

9. The method of claim 8, wherein the performing user authentication comprises:
acquiring the secret motion provided by the user in a form of image data;
acquiring the security code spoken by the user in a form of speech data; and
determining whether the secret motion matches a motion of the image data by performing motion recognition based on the image data, and determining whether the speech data matches the preset security code.

10. The method of claim 1, further comprising:
determining whether the user authentication fails and is repeatedly performed a predetermined number of times; and
upon determining that the user authentication is repeatedly performed a predetermined number of times or more, terminating an operation for a payment request.

11. A robot, comprising:
a body having an internal accommodation space formed therein;
a support part disposed below the body to support the body;
a display configured to display an image;
a head disposed on the body, the head having a front surface on which the display is disposed;
a voice input unit comprising a plurality of microphones (MICs) receiving a voice signal; and
a control unit configured to, upon receiving a payment command from a user, provide a request for speech of a security code, receive speech data on the security code from the user, and perform user authentication by comparing the speech data with the security code and comparing the speech data with a stored voice of the user.

12. The robot of claim 11, wherein, before providing a request for speech of the security code, the control unit generates the security code in a random manner, and provides the security code to the user.

13. The robot of claim 12, wherein the control unit provides the security code visually through the display.

14. The robot of claim 11, wherein the control unit performs voice recognition preprocessing with respect to the received speech data, analyzes an intention of the preprocessed speech data, and determines whether the analyzed speech data matches the security code.

15. The robot of claim 14, wherein the control unit compares the preprocessed speech data with stored user voice data to determine whether the preprocessed speech data matches the user voice data.

16. The robot of claim 12, wherein the security code is provided to the user acoustically.

17. The robot of claim 11, wherein the control unit further provides a request for a secret motion when making a request for speech of the security code.

18. The robot of claim 17, wherein the secret motion and the security code are preset.

19. The robot of claim 18, wherein the control unit acquires a secret motion provided by the user in a form of image data, acquires a security code spoken by the user in a form of speech data, determines whether the secret motion matches a motion of the image data by performing motion recognition based on the image data, and determines whether the speech data matches the preset security code.

20. The robot of claim 11, wherein the control unit determines whether the user authentication fails and is repeatedly performed a predetermined number of times, and, upon determining that the user authentication is repeatedly performed a predetermined number of times or more, terminates an operation for a payment request.
